(19) United States
(12) Patent Application Publication
(10) Pub. No.: US 2003/0236724 A1
(43) Pub. Date: Dec. 25, 2003

(54) Hotel planting method

(76) Inventors: Irena Baranova, (US); Craig Van Pelt, Saint Petersburg, FL (US)

Correspondence Address: STEPHEN E. FELDMAN, P.C., 12 East 41st Street, New York, NY, 10017, US

(21) Appl. No.: 10/178,137

(22) Filed: Jun. 24, 2002

(51) Int. Cl. G06F 17/60

(52) U.S. Cl. 705/35

(57) ABSTRACT

The present invention is directed toward a business method that provides for the floral decorating of a hotel room. The present invention describes a method for changing a typical hotel room into a high impact, visually appealing setting. Specifically, the method utilizes the materials as shown in U.S. Pat. No. 6,041,546 to Baranova, which describes a low maintenance system that can be used to decorate a typical hotel room with approximately thirty to forty live plants. Along with that of a visually appealing setting, a natural health benefiting system can also be created. Profits for an independent company are provided by a percentage of additional fees charged for an upgraded room such as described in the present invention.

### THE FIELD OF THE INVENTION

The present invention is directed toward a business method that provides for the floral decorating of a hotel room. Specifically, the present invention uses the materials as shown in U.S. Pat. No. 6,041,546 to Baranova to make it possible to decorate a typical hotel room with thirty to forty live plants. These plants are hung from the walls and ceilings in order to conserve the already limited floor space a typical hotel room provides. All of this is accomplished utilizing a system that is low maintenance and highly appealing.

### BACKGROUND OF THE INVENTION

A hotel is an establishment that provides lodging and usually meals and other services for travelers and other paying guests, and may be referred to as a hotel, motel, inn, lodge, or bed and breakfast. The hotel industry is a very large business in today's fast paced society. Many of today's businessmen and women are called on to travel from one place to another, and forced to spend many hours of their time in far away places across the country and the world. Those business travelers along with recreational travelers form the majority of those who utilize hotel facilities. A common problem to these people is the disconcerting feeling of being away from home in an uncomfortable and foreign environment. Frequently, hotels try to cure this problem by offering upgraded rooms that give the guest an above standard decorum. The present invention is directed towards a floral upgradeable room and the business method therein.

The present invention is a hotel room in which thirty to forty live plants are installed. The interiorscape presentation includes: floor planters, table-top planters, wall sconces, dish gardens and hanging baskets. Thus, the typical ban-en hotel room is converted into a high impact, visually appealing tropical setting.

U.S. Pat. No. 6,041,546 to Baranova describes a planter pouch comprising a bag shaped, flexible plastic bladder containing a polymeric growth. This patent is assigned to the present assignee and is utilized in the present invention. The disclosure of that patent allows the plants to be distributed throughout a hotel room without utilizing a vast majority of the floor space or requiring a devastating amount of maintenance.

U.S. Pat. No. 6,233,870 to Horibata discloses a device and a method for hydroponic or aquatic gardening in a restricted space of a dwelling, building or other structure This patent describes a system for the cultivation of vegetable plants in a restricted area. The disclosure of this patent is for cultivating vegetable plants inside and not for a system for keeping potted flowers in a hotel room. The present invention does not seek to create and grow plants, but rather keep already mature plants alive in a hotel room without requiring a lot of upkeep. While plants can cultivate and grow in the planter pouch, the current invention is not directed at growing plants, but rather to keep them alive for aesthetic purposes.

This prior art does not attempt to solve the problems that the present invention is designed to answer. The present invention comprises an indoor plant maintenance system. This system allows for the indoor keeping of plants at a low cost for a long period of time.

It should be clear to one skilled in the art, that the above discussed prior art is used for the purposes of illustration and should not be construed as limiting in any way, except for the prior art elements claimed in the above patents.

### SUMMARY OF THE INVENTION

The present invention provides a method for installing as many as thirty to forty live plants in a typical hotel room utilizing an already existing plant growing system.

Another object of the present invention is to require guests to pay a surcharge for a floral upgraded room.

Another object of the present invention is to improve guest satisfaction for a given hotel room.

Other objects of the present invention will become apparent from the foregoing description. It should be understood by one skilled in the art that the terms and identifications used by the applicant should not be interpreted as limiting the invention to a particular embodiment or object described above. Only the prior described above contains possible limitations to the present invention.

### BRIEF DESCRIPTION OF THE DRAWINGS

The following description of preferred embodiment of the present invention will be better understood when read in conjunction with the appended drawings. It should be understood, however, that the invention is not limited to the precise arrangements shown in which:

FIG. 1 is a chart showing the breakdown of surcharges for different levels of occupancy.

FIG. 2 is a flow chart showing the method of this invention.

### PREFERRED EMBODIMENT OF THE INVENTION

The present method is applicable in the hotel industry. The method describes the implementation of a floral decor in a typical hotel room, in order to both increase the visual impact of the room and the amount of money that can be charged for the room.

A hotel room of the invention is a typical hotel room in which thirty to forty live plants are installed. These plants are distributed throughout the room using various floor planters, table-top planters, wall sconces, dish gardens, and hanging baskets Customers using this type of room luxuriate in an extraordinary interiorscape presentation featuring an array of colorful, lush, tropical plants growing in motif-matching vessels. In addition to the beautiful visual impact, guests can be afforded important health benefits provided by the selection of plants, which purify, oxygenate, and humidify the ambient air.

The typical hotel usually provides enough room for its guests to move freely and store whatever baggage they may bring on their trips. However, the typical hotel does not usually have a lot of excess floor space. Nor does it tend to have an environment conducive to planting several dozen tropical plants that need frequent general up keep and other maintenance. The present invention makes this possible through the use of a planter pouch. This planter pouch consists of a bag shaped, flexible, plastic bladder having an open top and containing a polymeric growth medium The polymeric growth medium, as described in the Baranova patent, contains polymer crystals that absorb many times their weight in water. Upon contact with water, the crystals swell and are transformed into a gel-like substance. Roots, of any plant that is planted in the planter pouch, penetrate the chunks of gel and are able to absorb water and nutrients as required by the particular plant species. This eliminates the guesswork typically involved in general up keep of plants. No longer is it possible to water too much or too little. The plant species chooses when it requires water and nutrients. The planter pouch also eliminates the need to water on a frequent basis. Many species of plants can require watering multiple times daily. However, the planter pouch provides a medium in which evaporation is nearly eliminated and watering need only be done once approximately every six weeks. Finally, the planter pouch allows for plants to be grown without using floor planters, which can require generous amounts of space that a hotel room does not provide. The planter pouch now makes it possible to hang many plants without the fear of water escaping from the bottoms of their planters, while also allowing several plants to be planted in an area where one or less could be planted using conventional means.

Typically an upgraded room, like one in the present invention, garners a customary surcharge. This surcharge can range from $10.00 to $25.00 per night. The present invention provides a business model for utilizing the planter pouch in collection with a hotel room to create a business out of these surcharges.

The present invention allows for the company to establish a plant suite at a given hotel. The plant providing company takes on the responsibility of installing and all costs of the pertinent planting materials. This consists of the installation of floor planters, table-top planters, wall sconces, dish gardens, and hanging baskets These are all tailored to a specific motif, such as Southwestern, Tropical, etc . . . Once the various planters, sconces, and baskets are installed, as discussed above, it allows for a generally maintenance free and space-conserving array of plants.

Similarly, flower may be provided. The flowers to be planted once the necessary equipment is installed are also tailored after a specific motif Moreover, flowers and plants that provide specific health benefits to human beings will be planted. These plants or flowers may purify, oxygenate, or humidify the ambient air. A room that utilizes these types of flowers may not fit into a specific motif, but may be designed for the hotel guest that wants a healthier atmosphere. Those guests that may have health problems will be drawn to a room of this sort.

Upon completion of the plant suite, the company also assumes all of the operating costs and responsibilities. These may include the infrequent need to water the planter pouches, the trimming and pruning of the plants or flowers, and the general cleanup of the various planters, baskets, and sconces. These tasks can be done either by the company itself, or contracted out to another entity.

The company's income is derived from receiving 50-60% of the surcharges the hotel charges for the upgraded plant suite. Typically, a hotel guest may be required to pay ten to twenty five dollars per night extra for an upgraded room. Approximately half of this surcharge will now go to the plant suites company for its installation and general upkeep of the room The hotel will still be gaining a sufficient amount of profit for the room without taking care of the plants or flowers. Alternatively, the company may receive a minimum monthly guarantee against the total surcharges. This protects the company against negative costs in the event little to no plant suites are occupied.

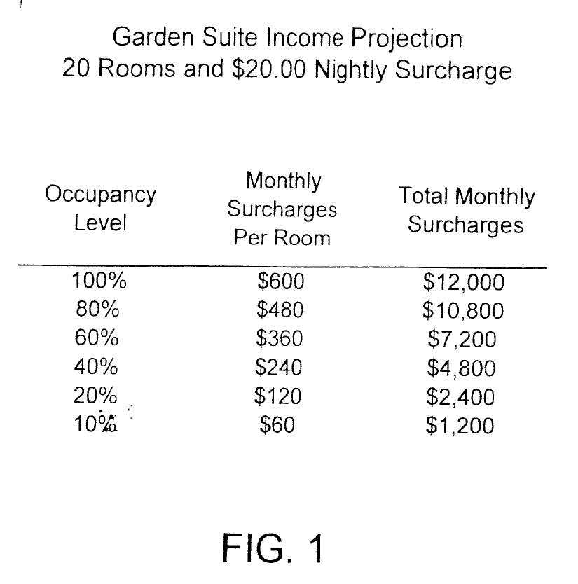

FIG. 1 is a chart showing the breakdown of surcharges for different levels of occupancy. The surcharges are shown on a monthly per room and a total monthly basis. These figures are achieved using an average twenty-dollar a might surcharge along with a total number of garden suites at twenty rooms. For a one hundred percent occupancy level, the monthly surcharges per room comes out to be six hundred dollars, while the total monthly surcharge for all of the rooms comes out to be twelve thousand dollars For a ten percent occupancy level, the monthly surcharges per room comes out to be sixty dollars, while the total monthly surcharge for all of the rooms comes out to be twelve hundred dollars. Looking at an average occupancy level of sixty percent, the monthly surcharges per room comes out to be three hundred sixty dollars, while the total monthly surcharge for all of the rooms comes out to be seven thousand two hundred dollars. Whatever the occupancy level, the income received from the surcharges will be fifty to sixty percent of the total surcharges. This gives the company anywhere from seven thousand two hundred dollars per month to six hundred dollars per month, while the hotel will be earning the remainder of the surcharges.

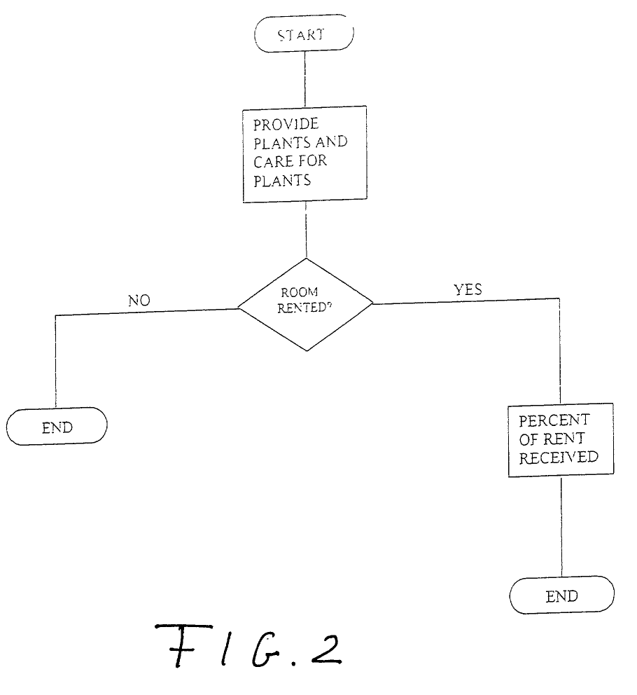

FIG. 2 is a flow chart showing the method of the invention. The outside company starts the process by providing plants to special predetermined rooms in a hotel. These rooms, or plant suites, are rented for a greater amount than normal rooms. If the plant suite is rented, the outside company receives a percent of this surcharge for the room.

Upon entering a hotel room of the type described in the present invention, a guest will visually be met with a vast array of plants or flowers that fit into a specific motif or serve a specific purpose. A hotel room that may have had minimal decorations and few, if any, floor planter will now have its walls and ceilings covered with various living plants or flowers. The original floor and overall storage space will be retained through the use of the above described means. However, plants and flowers will adorn the walls and hang from the ceilings, both in plants and sconces that also match the motif. Some plants or flowers will still be kept in floor planters, but now these planters will only need to be a fraction of the size. The room will not only have a beautiful floral display, but will also contain the many pleasing smells that accompany plants and flowers. In many cases, the room will give its guest the feeling of being outside in a pristinely kept garden. For these additional features, the guest will be charged an additional fee, like those that are collected for rooms that have additional amenities such as whirlpool bathtubs, king size beds, etc . . . This fee will be collected by the hotel and divided between the hotel and the independent company that provides the plants and their upkeep.

In the foregoing description of the invention, reference to the drawings, certain terms, have been used for clarity, conciseness and comprehension. However, no unnecessary limitations are to be implied from or because of the terms used, beyond the requirements of the prior art, because such terms are used for descriptive purposes and are intended to be broadly construed. Furthermore, the description and illustration of the invention are by way of example, and the scope of the invention is not limited to the exact details shown, represented, or described.

While the present invention has been described with reference to specific embodiments, it is understood that the invention is not limited but rather includes any and all changes and modifications thereto which would be apparent to those skilled in the art and which come within the spirit and scope of the appended claims.

What is claimed:

1. The method of providing plants to a hotel or guest room by an independent company comprising:
a. providing plants to the hotel or guest room;
b. charging, by the hotel, an additional fee for such a room; and,
c. dividing the additional fees between the hotel and the independent company.

2. The method of claim 1 where the capitalization and operation of the method is done by an independent company.

3. The method of claim 1 wherein a plastic material is used in which the plants

4. The method of claim 1 wherein said additional fees represent approximately ten to twenty five dollars per night, per room.

5. The method of claim 1 wherein flowers or plants can be used to decorate said room.

6. The method of claim 1 wherein said independent company collects approximately fifty to sixty percent of said additional fees.
